(19) United States
(12) Patent Application Publication
(10) Pub. No.: US 2017/0004548 A1
(43) Pub. Date: Jan. 5, 2017

(54) GENERATING AND RANKING SERVICE PROVIDER RECOMMENDATIONS IN A SOCIAL NETWORK

(71) Applicant: LinkedIn Corporation, Mountain View, CA (US)

(72) Inventors: Vaibhav Goel, Mountain View, CA (US); Laukik Watve, Sunnyvale, CA (US); Dino Pezzuti, San Jose, CA (US); Onkar Anant Dalal, Santa Clara, CA (US); Shuo Miao, Sunnyvale, CA (US); Dmitriy Afanasyev, St. Fair Lawn, NJ (US); Joseph Tsay, San Francisco, CA (US); Derek Lau, Sunnyvale, CA (US); Deepak Kumar, Mountain View, CA (US); Ajita Thomas, Sunnyvale, CA (US); Yi Zhang, Sunnyvale, CA (US); Brandon Dow, San Jose, CA (US); Jinyoung Chang, Palo Alto, CA (US)

(73) Assignee: LinkedIn Corporation, Mountain View, CA (US)

(21) Appl. No.: 14/755,015

(22) Filed: Jun. 30, 2015

(51) Int. Cl. G06Q 30/02; G06Q 50/00

(52) U.S. Cl. CPC G06Q 30/0282; G06Q 50/01

(57) ABSTRACT

In various example embodiments, a system and method for generating and ranking service provider recommendations in a social network are presented. A request to identify a set of service providers that meet a specific criteria is received. The request can be associated with a member of a social network service. Member profiles from among a plurality of member profiles of the social network service are identified based on the specific criteria. A plurality of attributes is extracted from the identified member profiles. A trust factor for each identified member profile indicating the likelihood that the member would trust the service provider is determined based on the extracted profile attributes. The set of service providers is ranked based on the determined trust factor. At least a portion of the set of ranked service providers may be caused to be presented to the member.

### TECHNICAL FIELD

Embodiments of the present disclosure relate generally to online social networking, and more particularly, but not by way of limitation, to generating and ranking service provider recommendations in a social network.

### BACKGROUND

Professional service providers (e.g., lawyers, doctors, real estate agents, taxi drivers, photographers, etc.) that function mainly on client services rely on attracting new clients in order to develop and maintain a successful and robust business. Providing accurate and trusted information may assist professional service providers in attracting new clients. Conventionally, members seeking a professional service provider on the internet relied on anonymous reviews by other members which lack authenticity. Such anonymous reviews may be made by anyone with no avenue for the member seeking a reliable and professional service provider to determine if the provider can be trusted.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed.

FIG. 2 is a block diagram depicting an example embodiment of a service provider system.

FIG. 3 is a flow diagram illustrating an example method for generating and ranking service provider recommendations in a social network, according to example embodiments.

FIG. 4 is a flow diagram illustrating an example method for determining the rank of service provider recommendations in a social network, according to example embodiments.

FIG. 5 depicts an example user interface for interactively presenting the service provider system to the member, according to example embodiments.

FIG. 6 depicts an example user interface for interactively presenting service providers to the member, according to example embodiments.

FIG. 7 depicts an example user interface for presenting updates and service providers associated with a previous search session to the member, according to example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Online professional network services such as LinkedIn® possess a significant directory of professionals seeking to maintain, build, and expand their network. A professional network service is a type of online social network service that focuses on interactions and relationships involving a professional and business nature rather than nonbusiness interactions. A professional network service is a platform that allows members to establish, build, and maintain professional networks or professional relations with other members of the network. Similarly, just as a professional network service allows for the construction of a professional network, a social network service allows for the construction of a social network. A person can join service providers such as LinkedIn® and become a member by building their online identity by adding credentials to their member profile and establish connections with other members of the professional network. These professionals include approximately twenty-six million service providers. The term service provider referred to herein is intended to include, but not limited to, individuals, organizations, or businesses which offer services in exchange for payment. For instance, these service providers can include lawyers, doctors, real estate agents, taxi drivers, photographers, etc. These service providers seek to build their brand and reputation in order to attract new clients and maintain existing clients. Brand and reputation can be developed on the internet through building a member profile and network connections on professional networks such as the online professional network LinkedIn®. It is appreciated that a member is a person with a profile account at the professional network service and a user comprise of members and guests that do not have an account. The descriptions herein use the term member, however in various embodiments, users can also be allowed to utilize the functionality described.

Members of a social networking service often look for services they need online that these service providers can offer. Current search engines and service directories lack the ability to match and connect members seeking specific services to specific service providers who are qualified and trusted by the member seeking the services. Therefore, a service provider system 200 (part of a social networking system 120) can be used in matching and recommending service providers that a member is more willing to trust by utilizing the member's professional network. In an example embodiment, the service provider system 200 provides functionality for service providers to screen potential clients. In another example embodiment, the service provider system 200 provides functionality for other members to seek out service providers without the motivation of seeking out the particular service itself. For instance, recruiters may seek specific people possessing specific skill sets and talents for the purpose of employment rather than the service.

The features of the present disclosure provide a technical solution to the technical problem of generating and ranking a list of professional service providers that the member would likely trust in response to a user query. The service provider system provides, in some embodiments, the technical benefit of providing a recommendation of service providers that have a high trust factor for the member.

In some examples, the trust factor may be calculated based on one or more attributes including: shared professional connections with the member's existing network, the service provider's established professionalism, professional expertise, and a shared affinity between the member and service provider, or any suitable combination thereof. Any of these four attributes singly or in combination is used to determine the trust factor for a specific service provider. In one embodiment, the trust factor uses a weighted sum algorithm, where the attributes of the trust factor are mathematically integrated over time with time-based weighting. In another embodiment, the weighting is based on a predetermined importance of each of the four attributes. In an example, the weight assigned to each of the attribute in decreasing order of importance: shared professional network, service provider's professional expertise, service provider's established professionalism, and then shared affinity, and then summed to calculate the trust factor. Since the shared professional network and shared affinity differs from member to member with respect to a certain service provider, the trust factor for each service provider may be different for each member. As a result, the service provider system provides a personalized list of service provider recommendations in response to a member input query, where the list of service providers is ranked based on shared professional network connections with the member, the service provider's expertise, shared affinity, and established professionalism. Accordingly, generating the list of service providers that take into account some or all of these attributes increase the trust factor and as a result the member would more likely use the service offered by the service provider. Additionally, other technical effects will be apparent from this disclosure as well.

In various example embodiments, systems and methods for generating service provider recommendations using a professional network service are described. A service provider system can be used in matching and recommending service providers that members are more willing to trust (e.g., have a high trust factor). As already noted, one attribute of the trust factor is shared professional connections with the member's existing network. This attribute is based upon how closely the service provider is connected with the member that is searching. Other members (e.g., service providers) within the members' direct professional network are called first degree connections, or others within the direct professional network of the members' first degree connections are called second degree connections, and others within the direct professional network of the members' second degree connections are called third degree connections, and so forth. The closer the degree of connection, the more likely the member would be willing to trust the service provider when compared to other providers who are not in the member's network.

Another attribute of the trust factor is the service provider's established professionalism. The attribute of established professionalism is an indication of the recognition of the service provider's professional achievement in the public at large. Such indications can include, for instance, articles the service provider has published, conferences that the service provider has presented at, and patents that an inventor has invented, and so on. Each of these factors that the service provider possesses is assigned predetermined point values, which are summed to create a score for the established professionalism, where the score is later used to form the trust factor. The predetermined point values may be the same for different types of factors (e.g., each conference presentation may be 1 point, and each article published may be 1 point), or may be different (e.g., each conference presentation may be 1 point, and each article published may be 2 points, and the like). Accordingly, the established professionalism attribute indicates that the service provider has some established authority in their professional field.

As already noted, yet another attribute of the trust factor is the service provider's professional expertise. A service provider's professional expertise in their area can be determined based on various attributes, including but not limited to reviews, recommendations, endorsements, level of education, years of experience, credentials, skills, accolades, as the like. Each of these attributes may be assigned predetermined point values, where the points are summed to create a score for the shared affinity and the score is later used to form the trust factor. The predetermined point values may be the same for different types of attributes (e.g., each year of experience may be 1 point, and each positive review may be 1 point), or may be different (e.g., each year of experience may be 1 point, and each positive review may be 2 points, and the like). In some examples, negative reviews subtract points.

As noted above, yet another attribute of the trust factor is a shared affinity between the member and service provider. The attribute of shared affinity includes characteristics that are similar between the service provider and member profiles. For instance, these characteristics can include having attended the same school, worked at the same company, similar hobbies, and the like. Each characteristic that is shared between the member and the service provider, a predetermined point value is assigned, where the points are summed to create a score for the shared affinity and the score is later used to form the trust factor. The predetermined point values may be the same for different types of attributes (e.g., each school attended that are shared may be 1 point, and each hobby shared may be 1 point), or may be different (e.g., each school attended that are shared may be 1 point, and each hobby shared may be 2 points, and the like)

In an example embodiment, a user interface for generating a list of service provider recommendations, responsive to a member query, is described. For instance, a member selects a set of criteria from a user interface to search for a service provider, where the set of criteria can include location and specific type of service provider. The result of the selection is a list of service providers based on the selected criteria. The list is ranked based on the determined trust factor, where the person with the highest determined trust factor is ranked first in the list. Trust factors can be calculated based on four attributes including: (1) the service provider's professional expertise in the area, (2) shared professional network between the service provider and the member, (3) established professionalism of the service provider within the type of field in which they provide their services, and (4) shared affinity between the member and the service provider, or any suitable combination thereof. In other words, the trust factor determines the likelihood that the member would trust a specific service provider and as a result more willing to seek to contact the service provider and engage their services. Alternatively, a member can sort the search results based on other desired factors, such as, number of endorsements, number of people shared within the network, number of years of experience, etc.

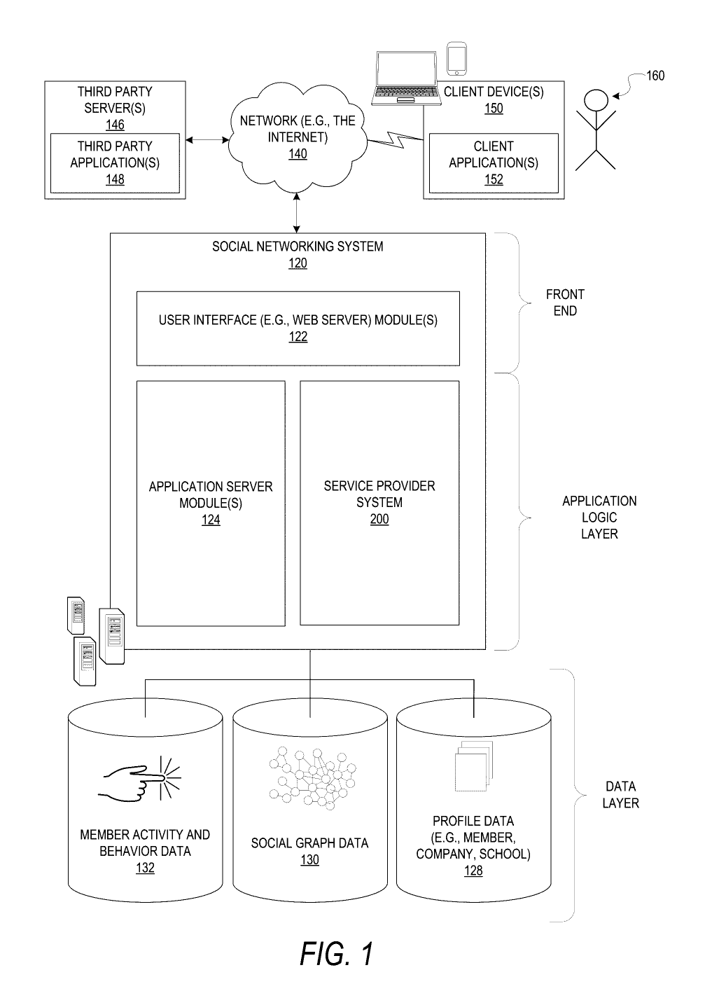

As shown in FIG. 1, the social networking system 120 may be based on a three-layered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-layered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing client application(s) 152 which may include conventional web browser applications and/or applications (also referred to as “apps”) that have been developed for a specific platform to include any of a wide variety of mobile computing devices and mobile-specific operating systems (e.g., iOS™, Android™, Windows® Phone). The client application(s) 152 may provide functionality to present information to the member and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more members 160 may be a person, a machine, or other means of interacting with the client device(s) 150. The member(s) 160 may interact with the social networking system 120 via the client device(s) 150. The member(s) 160 may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling members to search for and browse member profiles may be implemented with one or more application server modules 124. Of course, other applications and services may be separately embodied in their own application server modules 124. As illustrated in FIG. 1, social networking system 120 may include a service provider system 200, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

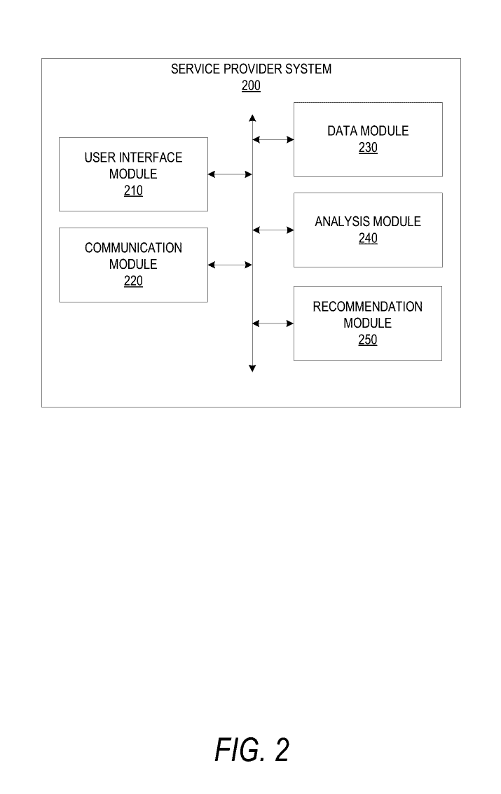

FIG. 2 is a block diagram showing example components provided within the service provider system 200, according to example embodiments. The service provider system 200 may include a user interface module 210, a communication module 220, a data module 230, an analysis module 240, and a recommendation module 250. All, or some, of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

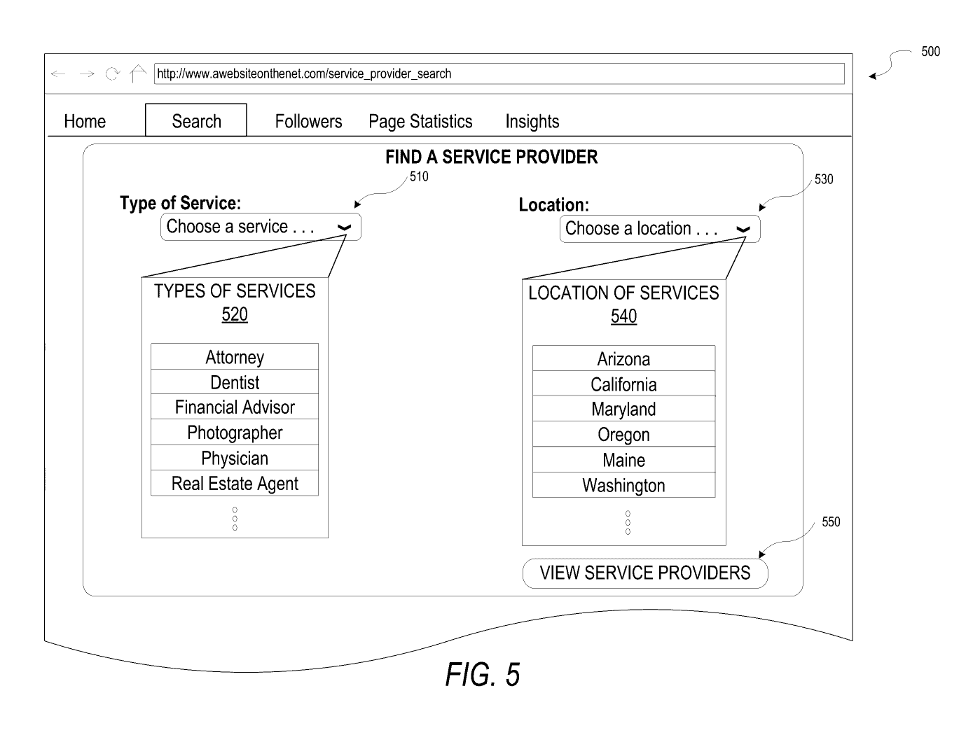

The user interface module 210 may provide a user interface that allows a member to search for service providers within the professional network and initiate a channel of communication with the service providers along with further operations as presented in FIGS. 5-7. Further, the user interface module 210 provides functionality for interactively presenting user interfaces to the member, receiving information from the member (e.g., interactions with user interfaces), and so on. Presenting information to the member is intended to include causing presentation of information to the member (e.g., communicating information to a device with instructions to present the information to the member). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth).

The communication module 220 may perform various communication functions to facilitate the functionality described herein. For example, the communication module 220 may communicate with the social networking system 120 via the network 140 using a wired or wireless connection. The communication module 220 may also provide various web services functions such as retrieving information from the third party servers 146 and the social networking system 120. In this way, the communication module 220 facilitates the communication between the service provider system 200 with the client devices 150 and the third party servers 146 via the network 140. Information retrieved by the communication module 220 may include profile data corresponding to the member 160 and other members of the social network service from the social networking system 120.

The data module 230 may provide various data functionality such as exchanging information with databases or servers. For example, the data module 230 may access member profiles that include profile data from the database 128. The data module 230 may also extract attributes and/or characteristics from the profile data of member profiles. Similarly, the data module 230 may access social graph data and member activity and behavior data may be accessed from respective databases 130 and 132. In some example embodiments, the data module 230 may exchange information with third party servers 146, client devices 150, and other sources of information.

In further example embodiments, the data module 230 categorizes the service provider in the professional network directory based on the level of skill required to perform the service and the type of opportunity sought (e.g., full-time, part-time, term contract, client-based, gig-based). The categorization is accomplished using a predefined list (e.g., of synonyms, related services, standard descriptors of a service or type of opportunity, or any suitable combination thereof). Some services require a highly skilled service provider while other services only require a low-skilled or unskilled service provider. For example, highly skilled service providers can include accountants, software developers, doctors, attorneys, etc. These highly skilled service providers require a certain amount of education and training in order to practice in the field. In this example, attorneys must hold a license in order to practice law or a doctor must be board certified in order to practice medicine. A low-skilled service provider requires less education and training than a high-skilled service provider. A low-skilled service provider can include a construction worker, physical therapist, disc jockey, etc. Unskilled service providers require little or no education or training and can include a custodian, maid, or taxi driver.

In various example embodiments, the analysis module 240 may perform a variety of analyses to facilitate the functionality described herein. For example, the analysis module 240 may analyze profile data and/or extracted attributes and/or characteristics from the profile data provided by the data module 230. In a specific non-limiting example, the analysis module 240 may compute the trust factor to determine the likelihood the member would trust the actual service provider associated with that member profile. In another specific example, the analysis module 240 may analyze the number of shared professional network connections between the member profile (i.e., the profile of the service provider) and the member profile (i.e., the profile the person seeking a service). In this specific example, the analysis module 240 assigns a higher weight to profiles that are at a closer degree of the first degree network connections. In other words, more weight is given to a member profile that has more people shared within their first degree network with the member (people who are in the direct network of both the member profile and the member profile) than compared to having a shared network of friends of friends (people who are in the second degree connections). The analysis module 240 may perform many other analyses.

In yet further example embodiments, the analysis module 240 assign a weight to each attribute (time-based weighting and variable for each type attribute) making up the service provider's trust factor. The weighted attributes are summed to create a score for the service provider's trust factor. In another embodiment, the weighting is based on a predetermined importance of each of the four attributes. In an example, the analysis module 240 assigns a weight to each of the attributes in decreasing order of importance: shared professional network, service provider's professional expertise, service provider's established professionalism, and then shared affinity, and then summed to calculate the trust factor. The weight assigned can be further based on the predetermined categorization of the type of service (e.g., highly skilled, low-skilled, unskilled). In another embodiment, the analysis module 240 calculates the trust factor by a sum of an average of the attributes of the trust factor.

In further example embodiments, the analysis module 240 determines a service provider's professional expertise in their area based on various attributes, including but not limited to reviews, recommendations, endorsements, level of education, years of experience, credentials, skills, accolades, etc. Each of these attributes is assigned points which are summed to create a professional expertise score, where the score is later used to determine the trust factor. Each attribute can be added to the profile by the member associated with that profile. In an example embodiment, the service provider can add credentials to their profile to showcase awards and accolades they have earned and therefore increase their expertise in their field of practice. Each member of the professional network can include a portfolio to showcase past work that they have accomplished. The portfolio of past work may be representative of the service that the member can provide. In yet another example, a real estate agent can include a portfolio of homes recently sold that would be accessible through the member profile.

In still further example embodiments, the analysis module 240 determines the service provider's professional expertise based on positive reviews, recommendations, or endorsements made by other members in the professional network. The number of reviews and who the reviews came from (relative to the degree of network of the reviewer to the member) affects the trust factor and thus affects the list ranking of the query result. Positive reviews, recommendations, and endorsements are assigned a heavier weight in determining the score for the service provider's professional expertise if the reviewer is a shared connection between the member and service provider's network. The analysis module 240 assigns the weighted point to each of the reviews, recommendations, and endorsements given to the service provider, the weighted points are summed to create a score for the established professionalism, where the score is used to form the trust factor. For example, a member seeking to purchase a home would search for a real estate agent within a specific location. The service provider system would return a list of real estate agents within that location. The list is ranked according to the degree of trust the member would place in the real estate agent. A real estate agent that has been recommended, endorsed, or given a positive review by a person within a first degree connection (directly within the network) would increase the member's trust in that real estate agent than compared to a person within a second degree connection (connection of a connection). Further, the weight associated with temporal information nearer the current time may have a larger value than weight associated with temporal information further in the past. The recommendation module 250 may use the assigned weight for the respective reviews and recommendations for determining the ranking of the service of providers to recommend to the member. Since the service provider's service is constantly changing, older data may provide less accurate information than more recent data. Therefore, older data may be associated with a lower weight when performing various analysis. Accordingly, a service provider that has many more positive reviews, recommendations, or endorsements than other service providers in the query result would be ranked higher in the list.

In still further example embodiments, the recommendation module 250 recommends a list of service providers to the member in response to a member query. In some examples, the trust factor can be determined at least partially based upon the number of people within the shared professional network between the service provider and the member. The shared professional network includes people who are in the direct first degree connection of both the member and the service provider. The analysis module 240 assigns a weight to each connection. A first degree connection is given more weight than a second degree connection, which is given more weight than a third degree connection, and so forth. A first degree connection is a first person a member is directly connected to in their professional network. A second degree connection is a second person who is one-step removed such that the first person in the member's direct network is connected to the second person. In other words, between the member and the second person, there is a shared network of the first person. Further, the recommendation module 250 can rank the list of service providers presented to the member based on the weight assigned to each attribute associated with the trust factor for each service provider, as described above. As described above, the number of people within the shared professional network may be assigned a higher weight than shared affinity or established professionalism in the field.

In various example embodiments, the analysis module 240 determines the service provider's established professionalism in the field as an expert based at least partially on the service provider being active in writing articles, discussing, and sharing their views and advice with others in the area of service. The more established the service provider is within the professional field, the more likely the member would trust the service provider. For instance, an immigration lawyer writes and publishes an article regarding navigating the visa or green card process in the United States of America. The article becomes widely read and is shared and seen by others interested in the article content. A high amount of traffic accessing that article or other article posting by that service provider indicates that the service provider has some establish authority within the field. In other embodiments, a high volume of article postings concerning the field of practice that the service provider provides also indicates that the service provider has some established authority in the field. These attributes associated with the activity contributes to a higher likelihood that the member would likely trust the service provider. The analysis module 240 assigns points to each factor contributing to the service provider's established professionalism; the points are summed to create a score for the established professionalism, where the score is used to form the trust factor. As already noted, these factors contributing to the service provider's established professionalism can include, for instance, articles the service provider has published, conferences that the service provider has presented at, and patents that an inventor has invented, and other similar factors indicating an established authority in a professional field.

In further various example embodiments, the analysis module 240 identifies that each review (including rating, or endorsement) that is provided is authenticated by connecting each review to the member that made the review. The analysis module 240 makes the identification available to the member at the member interface to see the member that made the review. In other words, the reviews are linked or connected to the reviewer's professional identity. The connection is provided by a link within the review space to the profile of the member making that review. The presence of the authentication associated with each review lends more weight and points to each of the authenticated review when calculating the professional expertise of a service provider. Alternatively, the credentials of the person making the review can be seen by hovering over the link or icon provided on the portion of the review. In further example embodiments, a member who is concerned about privacy has the option of partially disclosing the full content of their member profile. This partial identity option allows a member to limit the amount and scope of content other members can view in their full profile. A partial identity option discloses enough information for other members to confirm the review is a real person and therefore the trust is not undermined. However, in the interest of protecting the privacy of the reviewer, unique identifiers (i.e., full name and location) may be prevented from being associated with the review, thus protecting privacy while maintaining some authentication for the member. The extent of privacy prevents the reviewer from being specifically singled out and identified. For instance, a first member who has left a review for a real estate agent has limited their member profile content such that other members outside the first member's direct network (first degree connection) can only view the name, company of employment, and network connections. In this example, a second member seeking for a real estate agent looks at the review left the by first member can only view that Eric (first name) working for VMware (employer) with 500 connections has left the review for the real agent. In another example, a reviewer leaves an endorsement for a divorce lawyer but is not comfortable with using their professional identity. A partial identity option associates the review with “some at Microsoft,” with 430 connections, rather than disclosing the reviewer's full name and professional identity.

In various example embodiments, the analysis module 240 authenticates each review that is provided to a service provider by connecting each review to the member that made the review. Reviews can include online opinions by one member regarding the skill of service of another member of the professional network. Reviews can also include other forms of conveying opinions such as ratings (four out of five stars) or skill endorsement. A skill endorsement includes a positive affirmation that an endorser knows the endorsee possesses the skill that is endorsed. These endorsements also allow members to provide a positive signal about a specific attribute of the endorsee member.

In various example embodiments, the analysis module 240 determines the level of shared affinity between the member seeking a service and the service provider. The shared affinity affects the trust factor and therefore affects the list ranking of the query result. Shared affinity includes particular attributes, characteristics, or piece of information that is shared, may be similar, or intended to be similar to another attribute, characteristic, or piece of information. The shared affinity is compared between the attributes extracted from the member's profile and the attributes extracted from the service provider's member profile. For instance, the member and service provider may have a shared attribute of attending the same school or having worked for the same company. In yet further embodiments, the shared affinity can include shared interests between the member and service provider. The interests of the member is accessed or received from the member profile of each respective person and the analysis module 240 determines whether there is a match of interests between the member, who is a prospective client, and the service provider. The higher the number of matches between various interests the more compatible the personalities between the two people are predicted to be. For each characteristic that is shared between a member and a service provider, a point is assigned; the points are summed to create a score for the shared affinity, where the score is later used to form the trust factor. Accordingly, the analysis module 240 also determines the trust factor based on the characteristics associated with the shared affinity between the member seeking a service and the service provider.

In various example embodiments, the analysis module 240 determines the intent of a member searching for a service provider based on a member searching for a service provider at a specific location. The analysis module 240 further identifies the intent when the member initiates contact with a service provider in response to the member searching for a service provider in a current or previous search session. The intent of the member to enlist or use the services provided by a specific service provider is determined by identifying the request sent by the member and subsequent interactions with the list of recommendations presented to the member. Based on the identified request and subsequent interactions (the member clicking on service provider's profiles, viewing the profiles, and attempting to contact the service provider) the analysis module 240 can predict the type of service providers that the member is seeking. For instance, in a list of ten real estate agent recommended to the member, the member clicks on a real estate agent's profile, viewing the reviews, the shared connections, the profile expertise, the portfolio, and attempts to contact the real estate agent. Such activities indicate an intent by the member to enlist the service of the real estate agent. Where the member views multiple service providers' profiles, the analysis module 240 can determine the similar traits between the multiple service providers' profiles to determine that the intent of the member is to seek out service provider's having those traits. For instance, the member selects a request to seek a cardiologist serving the San Jose, Calif. area and thoroughly viewed six member profiles from a list of fifteen cardiologists recommend to the user. The analysis module 240 identifies similar traits between the viewed member profiles (i.e., identify that five out of the six viewed member profiles have completed their residency program at Stanford University and have been practicing in the field for more than ten years.) Thus, based on the identified similar traits shared between the viewed member profiles and the request sent, the analysis module 240 determines the intent of the member is to seek out a Stanford trained cardiologist practicing for more than ten years in the San Jose, Calif. area. In response to the determined intent, the service provider system, via the recommendation module 250, sends a list of service provider recommendations to the member that meet the requirements of the search criteria and would likely be trusted (measured by a trust threshold). The attributes that the analysis module 240 used to determine the trust factor are based on the same characteristics as described above, including the number of members in the shared network, shared affinity, expertise, or established professionalism of the service provider. The recommendation module 250 sends the recommendation, after the search session ends, to the member's email or adds the recommendation to the member's homepage feed which is accessible when the member next signs-in. For instance, John initiates a search for a real estate agent serving the San Francisco bay area. Within the list of search results, John looks at several real estate agent profiles. After John's search session, the recommendation module 250 emails John a list of recommendations for real estate agents serving the San Francisco area that have been recommended by John's coworkers or friends within his network. The recommendation module 250 updates the recommendation to reflect the updated information and activities by his network since his search session has ended. The email contains links to the professional profile of each real estate agent recommended. The list of recommendations may contain duplicates or service providers that John has viewed during his previous search sessions.

In various example embodiments, the analysis module 240 assigns a weight to each of the attributes used to determine the trust factor, which include the number of members in the shared network, shared affinity, professional expertise, and established professionalism of the service provider. In determining the trust factor, the factors that include higher frequencies of having other members in a member's network pre-vet the service provider is allocated a larger value. For instance, the attribute of number of members in the shared network is assigned a heavier weight than the attribute of shared affinity. Similarly, the attribute of professional expertise is assigned a heavier weight than the attribute of established professionalism.

In various example embodiments, the analysis module 240, in response to a member's input search criteria for a service provider, provides a list of service providers that meet the criteria to the member at the member interface. The member may further contact each of the service providers by selecting a contact icon or selector associated with each service provider in the returned list of recommendation provided. In response to a member choosing to contact the service provider, the analysis module 240 presents a list of questions to the member to facilitate the connection between member and service provider. The list can include questions that are required by the service provider in advance before the service provider would pursue any further action. The list of question is created by the service provider. Alternatively, the list of questions can be performed questions provided by the service provider system 200 that the service provider can choose from for the member to answer. The purpose of the question is for the member (a potential client) to provide details so the service provider can appropriately respond. For example, a realtor would require a potential client to answer a list of questions regarding the kind of house the client has in mind and whether the client has obtained a pre-approved loan. In this example, the realtor wants to prioritize clients according to how serious potential clients are at buying homes and therefore divide his time and attention accordingly. Alternatively, the list of questions can include questions that the member would like the service provider to provide the answer to before further engagement.

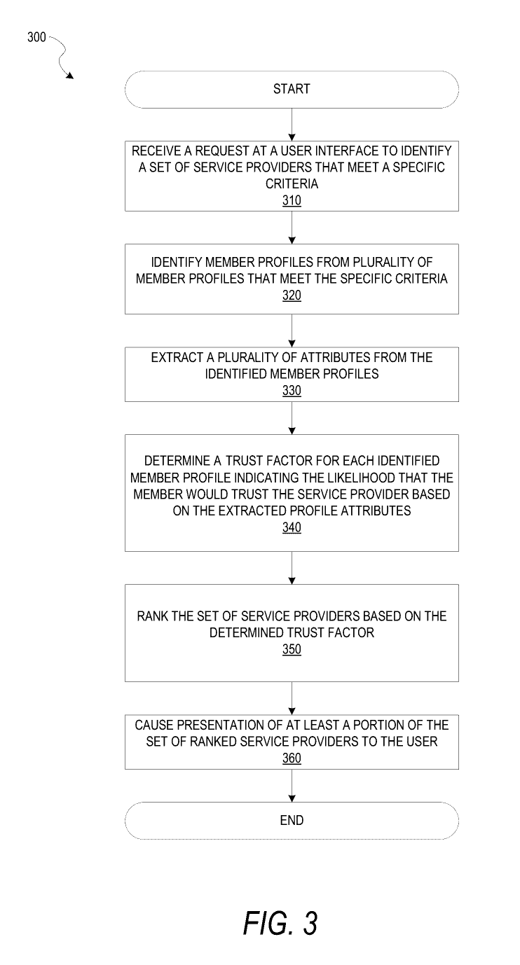

FIG. 3 is a flow diagram illustrating an example method 300 for determining a set of service providers meeting a member's criteria that the member would likely trust, according to example embodiments. The operations of the method 300 may be performed by components of the service provider system 200. At operation 310, the user interface module 210 may receive a request to identify a set of service providers that meet specific criteria. The request may be associated with the member of the professional network service. In an example embodiment, the member of the professional network service may provide an indication of the specific criteria (e.g., type of service sought and location, such as real estate agent in San Francisco) to a user interface configured to receive an indication of the specific criteria. In this example embodiment, the specific criteria may be a type of service selection and a location selection selected by the member from among a plurality of selections via a user interface configured to receive the type of service and location selections.

In another example embodiment, the service provider may be a member of the professional network service and current and/or past employment and location information may be included in the service provider's profile data. The specific criteria (i.e., type of service and location) submitted by the member searching for a service provider may be matched to the employment information of the service provider. For instance, the data module 230 may match a specific criteria corresponding to a particular job entry included in the employment information of the service provider (e.g., determine the type of service that the service provider providers based on text inputted for job title of the job entry field in the member profile data). The data module 230 may communicate the profile of the member with the job title located in the city that matches the specific job and location criteria to the user interface module 210 to be presented to the member as a recommendation.

At operation 320, the data module 230 may identify member profiles from among a plurality of member profiles of the professional network service that meet the specific criteria. In an example embodiment, member profiles of members of the professional network service that possess the specific criteria may be identified. For instance, the data module 230 may search for all, or some, member profiles of members of the professional network that hold a job title within the type of service and located or providing the service in the area specific by the criteria (e.g., searching database 128). The data module 230 can identify member profiles by determining a match between the specific criteria and the entries in the member profile. For example, a member can specify that he is looking for a real estate agent in San Jose, Calif. The data module 230 will identify all matches with member profiles with job titles and description matching real estate agent and their location being in San Jose, Calif. Alternatively, the identification of member profiles matching the specific criteria input by the member does not have to be an exact match, but rather a fuzzy match. For example, a member can specify patent lawyer in the Silicon Valley area as the specific criteria. The data module 230 then identifies all or some member profiles that fall under the patent lawyer criteria in the Silicon Valley. A patent lawyer can include any member that holds the job title of director, patent litigation, patent prosecution, partner, associate or of-counsel. In various example embodiments, members of the professional network service may be identified using member identifiers associated with member profiles of members. The member identifiers may be used to access additional profile data associated with members of the professional network service. Various additional identifiers in the member profile are utilized to determine whether the member profile does meet the specific criteria, such as job descriptions or level of education.

At operation 330, the data module 230 may extract a plurality of attributes from the identified member profiles. For example, each identified member profile of the identified member profiles may be associated with multiple attributes held by a particular member of the network and the particular member is associated with the identified member profile. In an example embodiment, the data module 230 may extract all, or some, of the attributes held by respective members of the identified member profiles. In various example embodiments, the data module 230 may extract the plurality of attributes from the identified member profiles. The attributes include job entries, education entries, skills, accolades, awards earned, or interests. Each entry is inputted by members of the professional network. Each job entry may include current and past job titles and company name, including descriptions associated with each job title. Each education entry may include current and past degrees received from respective universities or colleges. Each skill entry may include descriptions of tasks and abilities that the member possesses. Each accolade or award may include titles of honors and award that the member has achieved. The types of interests extracted may include professional or personal interests that the member is seeking to be involved in or currently involved with. For example, an employment lawyer may indicate a professional interest to be involved in pro-bono work for the underrepresented or with a nonprofit organization.

In various example embodiments, the data module 230 may extract other attributes associated with the identified member profile, including positive reviews, recommendations, or endorsements made by other members in the professional network. When a member includes an entry to endorse, recommend, or review another member, the entry is added to the profile data of the member being reviewed. Each extracted review, recommendation, or endorsement is associated with the member who made the review, recommendation, or endorsement, date it was made, time it was made, associated data of that reviewing member, and other associated data. The member being reviewed has the option to allow this entry to be viewed by the general public, and therefore have full control of the content that appears on their profile. Alternatively, the member being reviewed has no option to hide the entry and therefore even negative reviews will be associated with the member's profile.

In some example embodiments, the data module 230 may extract the attributes from the identified member profiles stored in database 128. In yet another example embodiment, the data module 230 may retrieve the attributes from the third party servers 146. For instance, company information corresponding to a particular job entry or education entry may not be included in the identified member profiles, but the data module 230 may retrieve general company and university information, and/or other information, from the third party servers 146 or other sources. In some example embodiments, the attributes may be derived and/or determined from various pieces of information. For example, the size of a typical company associated with a position may not be available directly, but may be inferred by the data module 230 based on member profiles that indicate employment at the company. The data module 230 may infer a wide variety of attributes from various information using many different schemes and techniques.

Referring back to FIG. 3, at operation 340, the analysis module 240 determines the professional expertise of the member profile and the number of shared professional network connections between the member profile and the member profile based on the extracted profile attributes. For example, an engineer with a Doctor of Philosophy (PhD) working at Microsoft with a title of software engineer for seven years is considered to have a high professional expertise in the field of software engineering. The analysis module 240 measures the level of professional expertise based on a threshold that can vary depending on the type of field. The professional expertise and the number of shared professional network connections make up the determination of the trust factor in which, the determination being performed by the analysis module 240.

At operation 350, the analysis module 240 further ranks the set of service providers based on the professional expertise of the member profiles and the number of shared professional network connections. The ranking reflects the likelihood that the member would trust the specific service provider. In other words, a member is more likely to trust a service provider if they have been pre-vetted within the member's own personal network along with the professional community at large. The ranking is based on the determined trust factor (i.e., the higher the determined trust factor for the service provider, the higher that service provider is ranked.) The level of professional expertise of the service provider is fully described above in association with the analysis module 240 described in FIG. 2. In other example embodiments, the trust factor may also include the established professionalism of the service provider and the shared affinity between the member and the service provider, as fully described in association with the analysis module 240 described in FIG. 2. In this example, the ranking of the set of service providers is then based on the trust factor which include the four attributes of service provider's professional expertise, shared professional network between the service provider and the member, established professionalism, and shared affinity, or any suitable combination thereof. The analysis module 240 calculates the trust factor using a weighted sum algorithm, where the attributes of the trust factor are integrated over time with time-based weighting. In another embodiment, the weighting is based on a predetermined importance of each of the four attributes of the trust factor, as fully described in association with the analysis module 240.

At operation 360, the recommendation module 250 causes presentation of at least a portion of the set ranked service providers to the member at the user interface. Further recommendations are also performed and described in further detail in associated with the recommendation module 250.

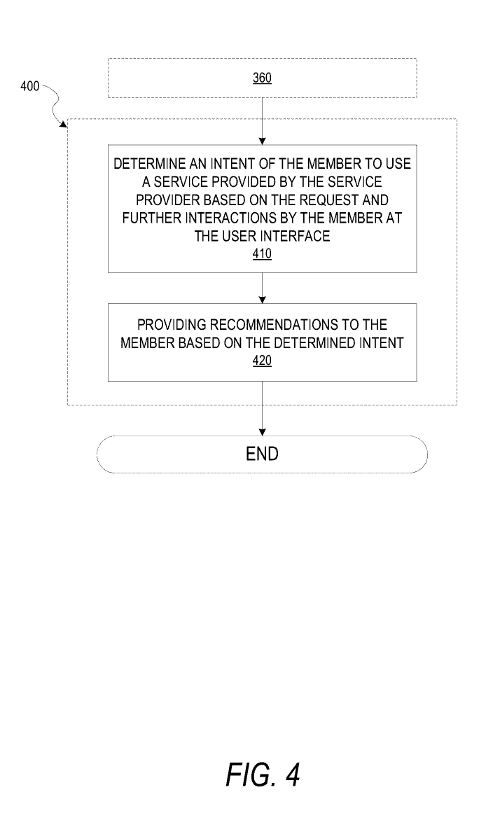

FIG. 4 is a flow diagram illustrating an example method 400 for determining an intent of the member associated with the request to identify a set of service providers that meet a specific criteria, the criteria selected by the member. The operations of the method 400 may be performed by components of the service provider system 200. At operation 410, the analysis module 240 determines the intent by identifying traits that are similar between the member profiles that the member has viewed. The similarity is determined by comparing the information fields between the viewed member profiles to determine textual matches. Based on the identified similar traits, the analysis module 240 determines that the intent of the member is to seek out service providers possessing those identified similar traits. At operation 420, in response to the determined intent, the recommendation module 250 sends a list of recommendations to the member, the list including service providers that have the identified similar traits that the member is seeking. The recommendation module 250 can send the list of recommendations to the member via an electronic message using an electronic email address the member has provided. The recommendation module 250 can further present the list of recommendations to the member's homepage feed, which is viewable when the member signs-in.

FIG. 5 depicts an example user interface 500 for interactively presenting the generating and ranking of service provider recommendations in a social network to the member. User interface element 510 and 530 may be a service provider navigation interface that allows the member to interactively navigate through service provider recommendations based on the types of services 520 and location of services 540 selected by the member. For instance, the member may choose a type of service at 510 through a drop down selection box 530 to find a real estate agent in the location selection 530. The location drop down 540 is categorized by state and once the member selects the state, the user interface 500 presents further sub-location categories such as cities. Each category selection 520 and 540 provided to the member at the user interface is associated with a database with a similar category structure. After selecting the types of services 520 and location of the desired services 540, the member can select view service providers 550 to view recommendations of service providers providing the types of services selected at 520 and located in the selection location 540. In this way, the member may interact with the service provider system 200 and navigate the selection of service providers.

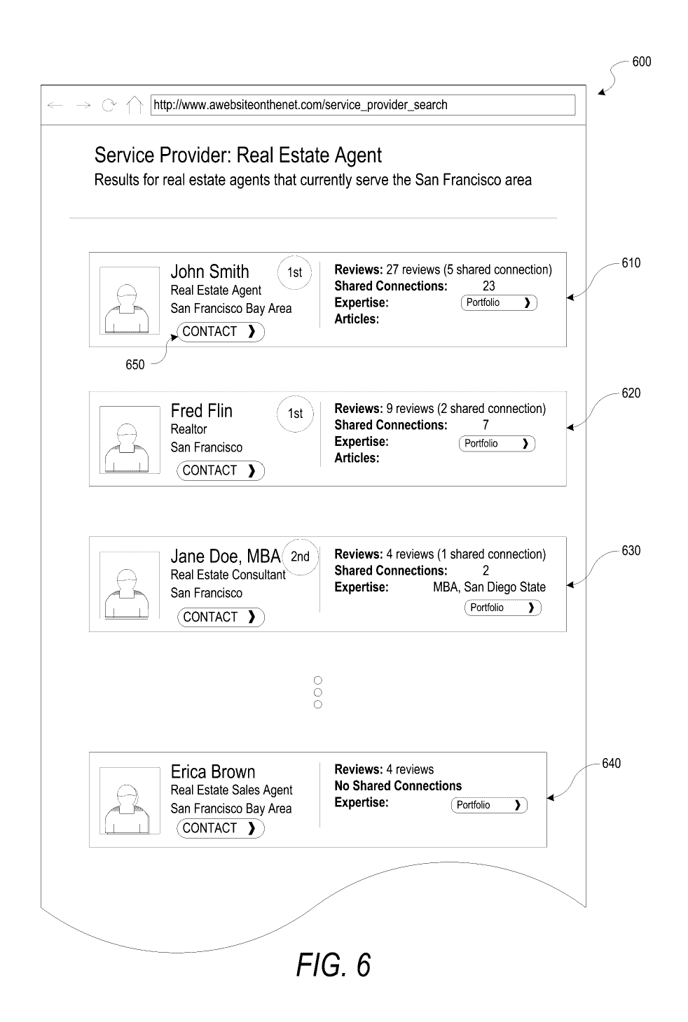

FIG. 6 depicts an example user interface 600 for interactively presenting a list of service providers recommended to the member in response to the member selection. In an example, the member is looking for a real estate agent in the San Francisco, Calif. area. The list of recommendations presented to the member by the user interface 600 includes real estate agents fitting the member-selected criteria 610, 620, 630, and 640. As described fully above in association with the analysis module 240 and recommendation 250, the list of service providers presented to the member is ranked according to the weight assigned to each attribute including the number of shared professional connections, professional expertise, established professionalism in the field, and shared affinity between the member and the service provider. In this example, the agent 610 is ranked higher in the recommendation list before he has more shared connections in the professional network than agent 620, 630, or 640. Further agent 610 also has higher number of positive reviews when compared to the other agents. The list is presented in order of the ranks of each service provider, from the highest ranked to the lowest ranked. Alternatively, the member can select his own filter, other than the default. For example, the member wishes to prioritize the service providers with more number of positive reviews than the other attributes because that attribute is more important to the member than the number of shared connections. The member can filter and prioritize the ranked list according to any of the attributes described above.

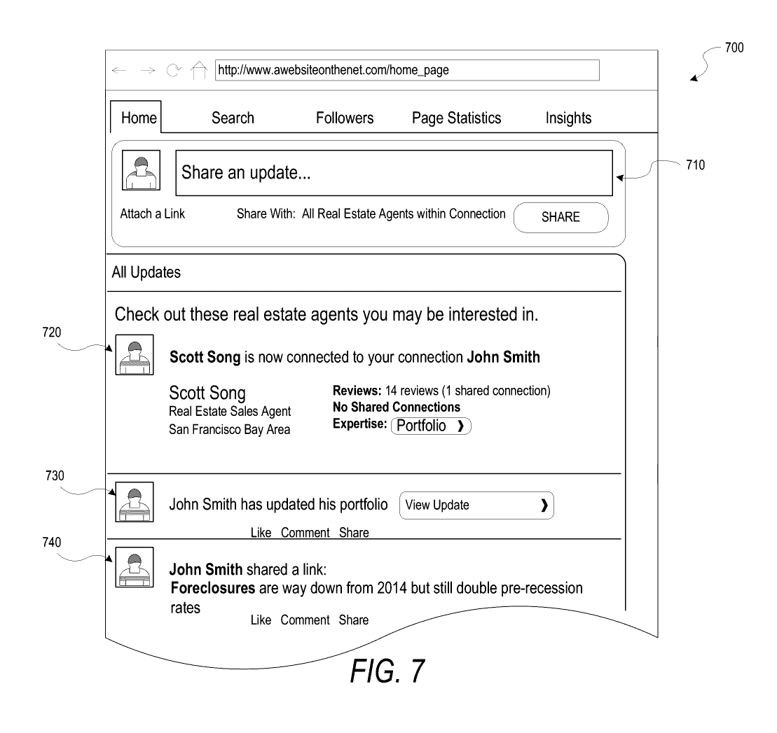

FIG. 7 depicts an example user interface 700 for interactively presenting further recommendations related to previous search sessions for service providers when the member signs-in. Continuing with the above example associated with FIG. 6, where the member in a previous session searched for a real estate agent in the San Francisco area. The analysis module 240 determines that the member was interest in certain real estate agents from the member's interaction with the user interface 600. For instance, the member has clicked to view the portfolio of John Smith 610 and attempted to contact John Smith by selecting contact 650. Further, the member may have viewed the reviews for John Smith and the give shared connections between the John Smith and the member. When the member next signs-in, the recommendation module 250, further recommends new connections that fit the member-selected criteria of the previous search session by the member. In an example, the real estate agent Scott Song 720 is newly connected to a person within the member's network, and therefore likely to be trusted by the member. The relevant information is further presented to the member at the interface 700 for the new recommended service provider. Additionally, the member can be prompted to share updates to ask questions related to the field to other service providers in the member's immediate network at input 710. In this way, the member can interact with all the real estate agents within the member's direct network to inquire about things associated with the real estate process of purchasing or renting a home, or the like. Moreover, the user interface 700 also presents to the member newly updated information relevant to the field of services that the member is interested in. For instance, the analysis module 240 determines that the member has an intent to engage in the services of John Smith for real estate services and thus presents relevant information that John Smith updates that is relevant to real estate services. The user interface 700 can present updates such as an updated portfolio 730 which relates to further expertise of the service provider in the field. The update of foreclosures 740 directly affects the real estate service and therefore would likely be of high interest to the member and thus also presented. In this way, the member can interact with the service provider system to select a service provider that would fit the member's needs.

### Modules, Components, and Logic

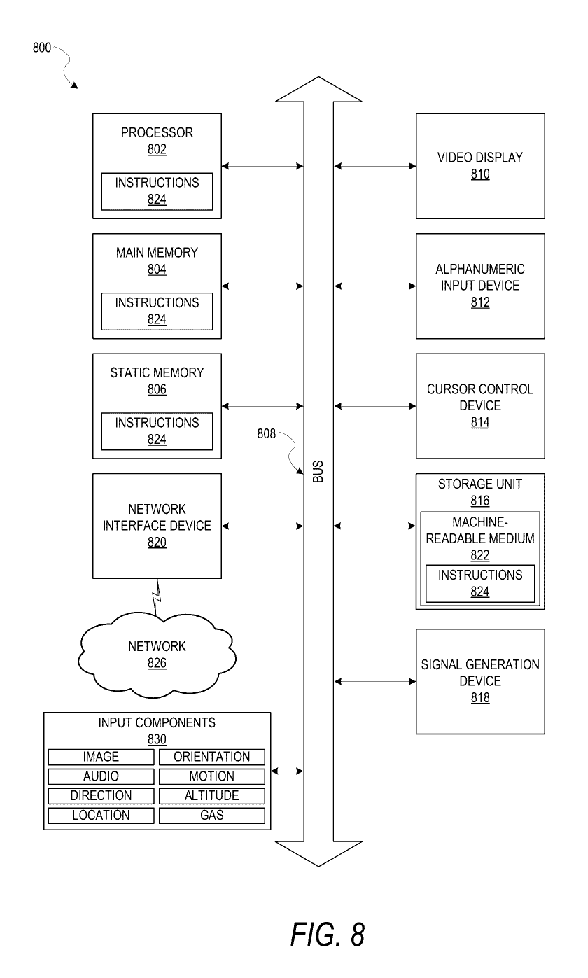

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies, associated with the service provider system 200, discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Any of these machines can execute the operations associated with the service provider system 200. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered as machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., WiFi and BlueTooth networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method comprising:
receiving a request at a user interface of a device to identify a set of service providers that meet a specific criteria, the request associated with a member of a social network service;
identifying member profiles from among a plurality of member profiles of the social network service that meet the specific criteria, each member profile associated with a service provider;
extracting a plurality of attributes from the identified member profiles;
determining a trust factor for each particular identified member profile indicating a likelihood that the member would trust the service provider associated with the particular identified member profile based on a comparison of attributes that are shared between a member profile of the member and the particular identified member profile, the shared member profile attributes being one of: education, work, or hobby attributes, the trust factor being further based on a number of first-degree and second-degree connections between each of the particular identified member profile and the member profile associated with the request, the determining being performed by a processor of a machine;
ranking the set of service providers based on the determined trust factors corresponding to each of the identified member profiles; and
causing presentation of at least a portion of the set of ranked service providers to the member at the user interface of the device.

2. The method of claim 1, wherein the trust factor for each of the particular identified member profiles is further based on a level of professional expertise of the particular identified member profile.

3. The method of claim 2, further comprising:
assigning a weight to each of the shared professional network connections based on degrees of network connection between each of the particular identified member profile and the member profile associated with the request; and
calculating the trust factor based on the assigned weight.

4. The method of claim 2, wherein the level of professional expertise of the member profiles include years of experience, number of member reviews, or number of endorsements.

5. The method of claim 1, further comprising:
wherein the determining the trust factor for each particular identified member profile comprises:
determining a level of shared affinity between the service provider associated with the particular identified member profile and the member based on the extracted profile attributes;
determining a level of established professionalism in the area of service associated with the service provider associated with the particular identified member profile based on the extracted profile attributes; and
calculating the trust factor based on the comparison of attributes and based upon the determined level of shared affinity and the level of established professionalism.

6. The method of claim 1, further comprising:
determining an intent of the member to use a service provided by the service provider associated with the particular identified member profile based on the request and further interactions by the member at the user interface; and
providing recommendations to the member based on the determined intent.

7. The method of claim 1, further comprising:
recommending a list of questions for the service provider associated with the particular identified member profile to require the member to answer; and
in response to the service provider creating questions to require the member to answer, presenting to the member the created questions.

8. A system comprising:
a processor, and a memory including instructions, which when executed by the processor, cause the processor to:
receive a request at a user interface of a device to identify a set of service providers that meet a specific criteria, the request associated with a member of a social network service;
identify member profiles from among a plurality of member profiles of the social network service that meet the specific criteria, each member profile associated with a service provider;
extract a plurality of attributes from the identified member profiles;
determine a trust factor for each particular identified member profile indicating a likelihood that the member would trust the service provider associated with the particular identified member profile based on a comparison of attributes that are shared between a member profile of the member and the particular identified member profile, the shared member profile attributes being one of: education, work, or hobby attributes, the trust factor being further based on a number of first-degree and second-degree connection between each of the particular identified member profile and the member profile associated with the request;
rank the set of service providers based on the determined trust factors corresponding to each of the identified member profiles; and
cause presentation of at least a portion of the set of ranked service providers to the member at the user interface of the device.

9. The system of claim 8, wherein the trust factor is further based on a level of professional expertise of the particular identified member profile.

10. The system of claim 9, wherein the level of professional expertise of the member profiles include years of experience, number of member reviews, or number of endorsements.

11. The system of claim 8, further comprising:
assign a weight to each of the shared professional network connections based on degrees of network connection between each of the particular identified member profile and a member profile associated with the request; and
calculate the trust factor based on the assigned weight.

12. The system of claim 8, further comprising:
wherein the determining the trust factor for each particular identified member profile comprises:
determine a level of shared affinity between the service provider associated with the particular identified member profile and the member based on the extracted profile attributes;
determine a level of established professionalism in the area of service associated with the service provider associated with the particular identified member profile based on the extracted profile attributes; and
calculate the trust factor based on the comparison of attributes and based upon the determined level of shared affinity and the level of established professionalism.

13. The system of claim 8, further comprising:
determine an intent of the member to use a service provided by the service provider associated with the particular identified member profile based on the request and further interactions by the member at the user interface; and
provide recommendations to the member based on the determined intent.

14. The system of claim 8, further comprising:
recommend a list of questions for the service provider associated with the particular identified member profile to require the member to answer; and
in response to the service provider creating questions to require the member to answer, present to the member the created questions.

15. A machine-readable medium not having any transitory signals and storing instructions that, when executed by at least one processor of a machine, cause the machine to perform operations comprising:
receiving a request at a user interface of a device to identify a set of service providers that meet a specific criteria, the request associated with a member of a social network service;
identifying member profiles from among a plurality of member profiles of the social network service that meet the specific criteria, each member profile associated with a service provider;
extracting a plurality of attributes from the identified member profiles;
determining a trust factor for each particular identified member profile indicating a likelihood that the member would trust the service provider associated with the particular identified member profile based on a comparison of attributes that are shared between a member profile of the member and the particular identified member profile, the shared member profile attributes being one of: education, work, or hobby attributes, the trust factor being further based on a number of first-degree and second-degree connection between each of the particular identified member profile and the member profile associated with the request;
ranking the set of service providers based on the determined trust factors corresponding to each of the identified member profiles; and
causing presentation of at least a portion of the set of ranked service providers to the member at the user interface of the device.

16. The machine-readable medium of claim 15, wherein the trust factor for each of the particular identified member profiles is further based on a level of professional expertise of the particular identified member profile.

17. The machine-readable medium of claim 16, wherein the professional expertise of the member profiles include years of experience, number of member reviews, or number of endorsements.

18. The machine-readable medium of claim 15, wherein the operations further comprise:
determining an intent of the member to use a service provided by the service provider associated with the particular identified member profile based on the request and further interactions by the member at the user interface; and
providing recommendations to the member based on the determined intent.

19. The machine-readable medium of claim 15, wherein the operations further comprise:
recommending a list of questions for the service provider associated with the particular identified member profile to require the member to answer; and
in response to the service provider creating questions to require the member to answer, presenting to the member the created questions.

20. (canceled)
